(19) United States
(12) Patent Application Publication
(10) Pub. No.: US 2010/0024183 A1
(43) Pub. Date: Feb. 4, 2010

(54) REMOVABLE TOOL FOR A DISPLAY ASSEMBLY

(76) Inventor: Lawrence M. Cuprys, Felton, CA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/493,359

(22) Filed: Jun. 29, 2009

Related U.S. Application Data
(60) Provisional application No. 61/076,812, filed on Jun. 30, 2008.

(51) Int. Cl. B25B 27/00

(52) U.S. Cl. 29/270

(57) ABSTRACT

A removable tool for a display assembly wherein the display assembly includes a base housing, a lens assembly mounted to the base housing by a plurality of radial locking tabs extending from one of the lens assembly and the base housing, and a display unit having a matrix display contained within a display housing mounted in optical alignment with the lens assembly. The removable tool can include a body having a series of removal protrusions corresponding to the radial locking tabs of the one of the lens assembly and the base housing which are simultaneously axially positionable and insertable inline with openings in the lens assembly to simultaneously disengage the radial locking tabs upon insertion of the removal protrusions into the openings in the lens assembly, thereby disassembling the lens assembly from the base housing.

### RELATED APPLICATION

This application claims the benefit of U.S. Provisional Application No. 61/076,812, filed on Jun. 30, 2008. The entire teachings of the above application are incorporated herein by reference.

### BACKGROUND

A display assembly, for example, an eyepiece viewer, can have a lens assembly that is mounted to a display housing in optical alignment with a matrix display by components that lock together. There are times when it is desirable to remove the lens assembly from the display base for maintenance or repair. However, due to the locked components, this typically is not possible without damaging or destroying one of the components.

### SUMMARY

The present invention can provide a removable tool for a display assembly. The display assembly can include a base housing, a lens assembly mounted to the base housing by a plurality of radial locking tabs extending from one of the lens assembly and the base housing, and a display unit having a matrix display contained within a display housing mounted in optical alignment with the lens assembly. The removable tool can include a body having a series of removal protrusions corresponding to the radial locking tabs of the one of the lens assembly and the base housing which are simultaneously axially positionable and insertable inline with openings in the lens assembly to simultaneously disengage the radial locking tabs upon insertion of the removal protrusions into the openings in the lens assembly, thereby disassembling the lens assembly from the base housing.

In particular embodiments, the series of removal protrusions can extend from the body in a generally circular pattern relative to a central axis and can include pairs of removal protrusions adjacent to each other. The removal protrusions can extend perpendicularly from a planar face of the body and parallel relative to the central axis. Each pair can be spaced equidistantly from each other. Each removal protrusion can have a generally flattened rectangular cross section and can have a stem extending from the body with a narrow insertion tip extending from the stem. An angled portion can connect the insertion tip to the stem on a side facing radially inward relative to the central axis.

The present invention can also provide a removable tool and display assembly combination having a base housing and a lens assembly mounted to the base housing by a plurality of radial locking tabs extending from one of the lens assembly and the base housing. A display unit having a matrix display contained within a display housing can be mounted in optical alignment with the lens assembly. A removable tool can be included and have a series of removal protrusions corresponding to the radial locking tabs of the one of the lens assembly and the base housing which are simultaneously axially positionable and insertable inline with openings in the lens assembly to simultaneously disengage the radial locking tabs upon insertion of the removal protrusions into the openings in the lens assembly, thereby disassembling the lens assembly from the base housing.

In particular embodiments, the series of removal protrusions can extend from a body in a generally circular pattern relative to a central axis and can include pairs of removal protrusions adjacent to each other. The removal protrusions can extend perpendicularly from a planar face of the body and parallel relative to the central axis. Each pair can be spaced equidistantly from each other. Each removal protrusion can have a generally flattened rectangular cross section and can have a stem extending from the body with a narrow insertion tip extending from the stem. An angled portion can connect the insertion tip to the stem on a side facing radially inwardly relative to the central axis. The radial locking tabs can extend radially inwardly from the lens assembly for engaging a mating locking structure in the base housing. The base housing can include three deflectable flange members, each having a locking recess for engaging a corresponding radial locking tab. The deflectable flange members can be capable of being deflected radially inwardly by the removal protrusions for disengaging the radial locking tabs from the locking recesses in the deflectable flange members. The deflectable flange members can include segments of a cylindrical member separated from each other by slots to allow deflection radially inwardly.

The present invention can also provide a display assembly having a base housing with a series of deflectable flange members which can include segments of a cylindrical member separated from each other by slots to allow deflection radially inwardly. A lens assembly can be mounted to the base housing by a plurality of radial locking tabs extending from one of the lens assembly and the deflectable flange members of the base housing. The lens assembly can include openings for allowing simultaneous axial insertion of a series of removal protrusions from a removable tool corresponding to the radial locking tabs to simultaneously disengage the radial locking tabs by deflecting the deflectable flange members radially inwardly upon insertion of the removal protrusions into the openings in the lens assembly, thereby disassembling the lens assembly from the base housing when desired. A display unit having a matrix display contained within a display housing can be mounted in optical alignment with the lens assembly.

In particular embodiments, three radial locking tabs can extend radially inwardly from the lens assembly for engaging a mating locking structure in the base housing. The base housing can include three deflectable flange members, each having a locking recess for engaging a corresponding locking tab.

The present invention can also provide a method of removing a lens assembly from a display assembly. The display assembly can include a base housing with the lens assembly mounted to the base housing by a plurality of radial locking tabs extending from one of the lens assembly and the base housing, and a display unit including a matrix display contained within a display housing mounted in optical alignment with the lens assembly. The method includes simultaneously axially inserting removal protrusions of a removable tool corresponding to the radial locking tabs inline with openings in the lens assembly to simultaneously disengage the radial locking tabs, thereby disassembling the lens assembly from the base housing.

In particular embodiments, the removal protrusions can extend from a body and can be positioned in a generally circular pattern relative to a central axis. The removal protrusions can extend perpendicularly from a planar face of the body and parallel relative to the central axis. The removal protrusions can be adjacent to each other in pairs. Each pair can be spaced equidistantly from each other. The removal protrusions can have generally flattened rectangular cross sections and each can have a stem with a narrow insertion tip. An angled portion can connect the insertion tip to the stem on a side facing radially inwardly relative to the central axis. Three radial locking tabs that extend radially inwardly from the lens assembly can be disengaged from a mating locking structure in the base housing. Three deflectable flange members of the base housing can be deflected radially inwardly, each having a locking recess engaging a corresponding radial locking tab. Deflection of the deflectable flange members can disengage the radial locking tabs from the locking recesses. The deflectable flange members can include segments of a cylindrical member that are separated from each other by slots to allow deflection radially inwardly.

The present invention can also provide a method forming a display assembly. A base housing can be provided having a series of deflectable flange members which can include segments of a cylindrical member separated from each other by slots to allow deflection radially inwardly. A lens assembly can be mounted to the base housing with a plurality of radial locking tabs extending from one of the lens assembly and the deflectable flange members of the base housing. The lens assembly can include openings for allowing simultaneous axial insertion of a series removable protrusions of a removable tool corresponding to the radial locking tabs to simultaneously disengage the radial locking tabs by deflecting the deflectable flange members radially inwardly, thereby disassembling the lens assembly from the base housing where desired. A display unit including a matrix display contained within a display housing can be mounted in optical alignment with the lens assembly.

In particular embodiments, three radial locking tabs can extend radially inwardly from the lens assembly for engaging a mating locking structure in the base housing. The base housing can include three deflectable flange members, each having a locking recess for engaging a corresponding locking tab.

In the present invention, a lens assembly that is securely locked to a base housing with multiple locking components, can be disassembled from the base housing with the removable tool without damaging or destroying any components. This can allow the display assembly to be easily and quickly disassembled for repair or maintenance of the lens assembly or components in the base housing. Since components are not damaged in the disassembly process, repair and maintenance can be performed in an efficient and cost effective manner.

### BRIEF DESCRIPTION OF THE DRAWINGS

FIG. 1 is a side sectional view of one embodiment of a display assembly.

FIG. 2 is a perspective view of an embodiment of a display base housing.

FIG. 3 is a partial perspective view of a lens assembly housing locked to the display base housing with a removable tool positioned for insertion.

FIG. 4 is a perspective view of one embodiment of a removable tool.

FIG. 5 is a front view looking into an embodiment of the lens assembly housing.

FIG. 6 is a partial side sectional view depicting the insertion of the removable tool for disengaging the lens assembly housing from the display base housing.

FIG. 7 is a schematic drawing depicting the insertion of a removable tool in another locking configuration.

### DETAILED DESCRIPTION

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

The present invention includes a removable tool for a display assembly. The display assembly can have a lens assembly mounted and secured to a base housing by a plurality of locking tabs. The removable tool can have a series of removal protrusions corresponding to the locking tabs, which upon insertion into the display assembly, can simultaneously disengage the locking tabs and disassemble the lens assembly from the base housing.

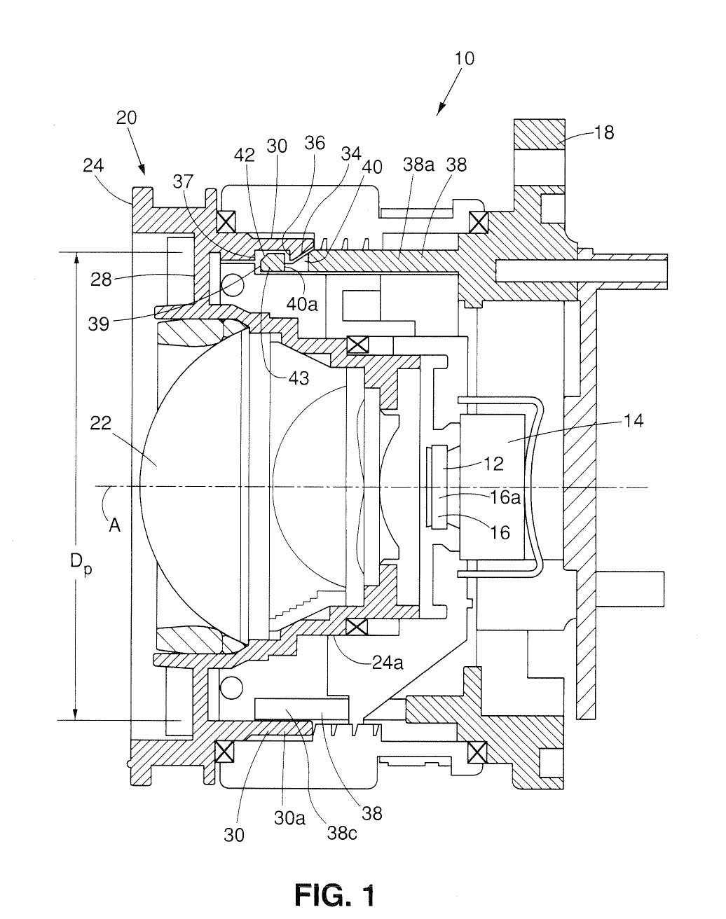

Referring to FIG. 1, display device, apparatus or assembly 10 is one embodiment in the present invention. Display assembly 10 can be a viewing device and can be an eyepiece viewing device. Display assembly 10 can include a base housing 18. A display unit 12 for generating images can be contained and mounted within base housing 18. Display unit 12 can include a display 16 contained with a display housing 16a. Display 16 can be a liquid crystal display (LCD) or matrix display, or other suitable display. A backlight 14 can be positioned inline with the display 16 along an axial, optical, longitudinal or central axis A, for illuminating the display 16, and in some embodiments, can be included as part of the display unit 12. A lens assembly 20 having optics 22, such as viewing optics, can be positioned in optical alignment with display unit 12 along axis A and can be secured and mounted to the base housing 18 for viewing images generated by display 16.

The lens assembly 20 can have a lens assembly housing 24 for housing the optics 22 within an inner housing portion 24a. The lens assembly housing 24 can include a securement or mounting member or flange 30 which can be a generally cylindrical flange or diameter. The flange 30 can extend concentrically around or outside at least a portion of the optics 22 and inner housing portion 24a, and about or parallel to axis A. A series of locking members, protrusions or tabs 34 can be positioned on interior, inwardly facing, or inner surfaces or inner diameter of the flange 30, and can face or extend radially inwardly from the flange 30. The radial locking tabs 34 can be integrally formed in the flange 30, and can be curved, ramped or angled on the distal or axial end.

The base housing 18 can include a securement or mounting member or flange 38. The flange 38 can be a generally cylindrical flange or diameter, and can include a series of locking members, structures, holes or recesses 40, which can be on the exterior, outwardly, or outer facing surfaces or outer diameter of the flange 38.

When the lens assembly 20 is secured to the base housing 18, at least a distal or an axial end portion 30a of the flange 30 of the lens assembly housing 24 can engage and fit around a distal or axial end portion 38c of flange 38 of the base housing 18. The flange 38 can extend concentrically around at least a portion of the optics 22 and inner housing portion 24a, and about or parallel to axis A. The diameters of the flange 30 and the flange 38 can have a close sliding fit with each other. The flanges 30 and 38 can engage each other along a pitch circle diameter Dₚ. The flange 30 of the lens assembly housing 24 can be locked around and to the flange 38 of the base housing 18 by the series of locking tabs 34. The locking tabs 34 can radially engage corresponding locking recesses 40 in the flange 38. Ramped or angled radial locking tabs 34 can allow easier passage or sliding of the locking tabs 34 over the outer diameter or surfaces of flange 38 before entry into the locking recesses 40. The distal or axial end 39 of the flange 38 at least in portions aligned with the locking recesses 38 can also have a curved, ramped or angled surface 42 for also aiding passage of the locking tabs 34. The radial locking tabs 34 can have a shoulder 36 which can face and engage the distal or one side 40a of the locking recesses 40. This can engage and trap the portion 43 of the axial end 39 of flange 38 adjacent to the locking recess 40 between shoulder 36 and a shoulder 37 on flange 30, thereby locking the axial end 39 of flange 38 against the lens assembly housing 24, which axially locks the lens assembly 20 to the base housing 18. Engaging the flange 30 around or over flange 38 can provide lateral or radial locking. In addition, the width of the locking recesses 40 and the locking tabs 34 can be sized to closely fit relative to each other to rotationally lock the lens assembly 20 relative to base housing 18.

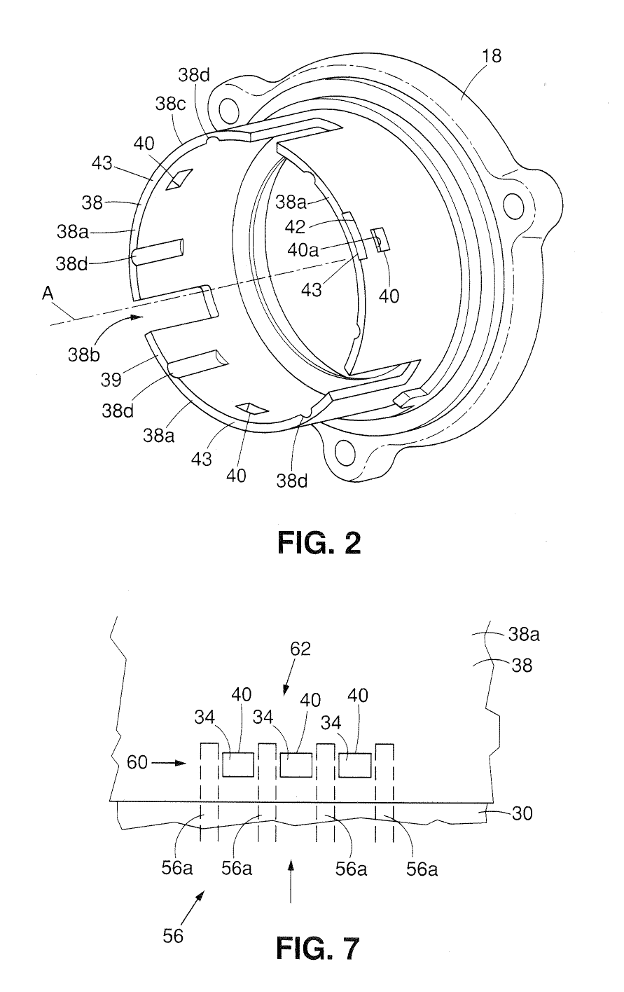

Referring to FIG. 2, the flange 38 of the base housing 18 can have deflectable flange segments, portions or members 38a formed and separated from each other by longitudinal or axially extending slots 38b in the flange 38 which can reduce the radial stiffness of the flange members 38a to allow sufficient deflection radially inwardly towards axis A and away from the flange 30 and the pitch circle diameter Dₚ. The slots 38b can axially extend most of the length of flange 38. The slots 38b can also aid in the proper motion for focus adjustment of the lens assembly 20. One or more longitudinal or axially extending shallow slots, recesses, trenches, depressions or grooves 38d can be formed in the deflectable flange members 38a, which can also reduce the radial stiffness of the deflectable flange members 38a. The grooves 38d can be formed on the interior, inwardly facing, or inner surface of the deflectable flange members 38a, but alternatively, can be on the outer surface. Two grooves 38d can be formed in each deflectable flange member 38a, one on each side of a locking recess 40. The grooves 38d can have a depth that is about one third the wall thickness of flange 38, and an axial or longitudinal length which can extend from the distal end 39 to a point beyond or past the longitudinal location of the locking recesses 40. The deflectable flange members 38a can be curved or arched segments or portions of the generally cylindrical flange 38. The deflectable flange members 38a can deflect radially inwardly to allow passage of the radial locking tabs 34 over portions 43 before engaging the locking recesses 40, or for removal. The slots 38b can allow the deflectable flange members 38a to radially bend or deflect as a cantilevered beam, and grooves 38d can allow the region of the deflectable flange members 38a between the grooves 38d and around locking recesses 40 to locally depress, deform or bend to radially deflect the regions of the deflectable flange members 38a at the locking recesses 40. This can provide radial deflection of the deflectable flange members 38a in two stages and in two different ways.

In one embodiment, The flange 38 of the base housing 18 can have three deflectable flange members 38a which can be of equal size, and each deflectable flange member 38a can include a locking recess 40 centrally positioned on the curved perimeter equidistant or 120° apart from each other, for alignment with a radial locking tab 34. As a result, the flange 30 of the lens assembly housing 24 can have three corresponding or mating radial locking tabs 34 positioned equidistantly from each other around axis A, or about 120° apart and aligned for engagement with the locking recesses 40 along the pitch circle diameter Dₚ at equidistant locations to provide secure circular locking. In other embodiments, more than three, or less than three radial locking tabs 34, deflectable flange members 38a and locking recesses 40 can be employed. The length and width of the slots 38b, and the length, width, depth and number of the grooves 38d can be varied to obtain the desired deflection characteristics of the deflectable flange members 38a. The use of multiple radial locking locations can provide simultaneous circular locking along the pitch circle diameter Dₚ at the multiple locations. This can allow the lens assembly 20 to be axially inserted into the base housing 18 along axis A and locked in place in one step or operation.

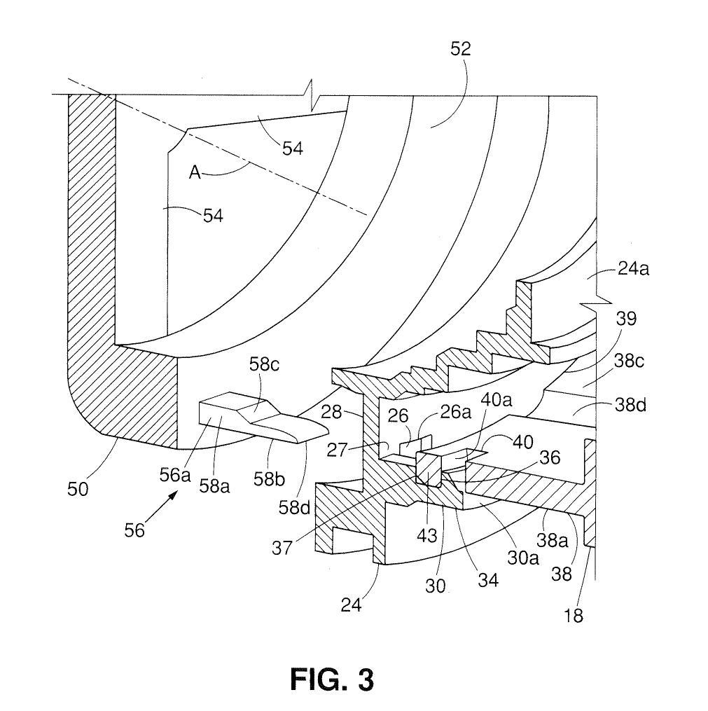

Once the lens assembly housing 24 of the lens assembly 20 is locked to the base housing 18, the lens assembly 20 cannot be easily removed from the base housing 18, for example, by mere pulling of these components in opposite directions, since the shoulder 36 of each radially locking tab 34 is locked against the distal side 40a of a locking recess 40. If repair or maintenance is desired which requires the lens assembly 20 to be removed, a removable tool 50 can be employed to remove the lens assembly 20 from the base housing 18 without damaging or destroying any of the components. Referring to FIGS. 3-6, removable tool 50 can have a series of wedge or spreading insertable removal protrusion structures 56 which extend from a planar face of a body 52 in an axial or longitudinal manner parallel to axis A. The removal protrusion structures 56 can be spaced equidistantly apart from each other in a generally circular pattern around or about axis A. The removal protrusion structures 56 can be positioned along a circle that can be close to or along the pitch circle diameter Dₚ. The body 52 can be circular as shown, and can have connecting spokes 54. Alternatively, body 52 can have other configurations, and can be solid, and can have other suitable shapes. The number, positioning and spacing of the removal protrusion structures 56 can correspond to the number of radial locking tabs 34 or locking recesses 40.

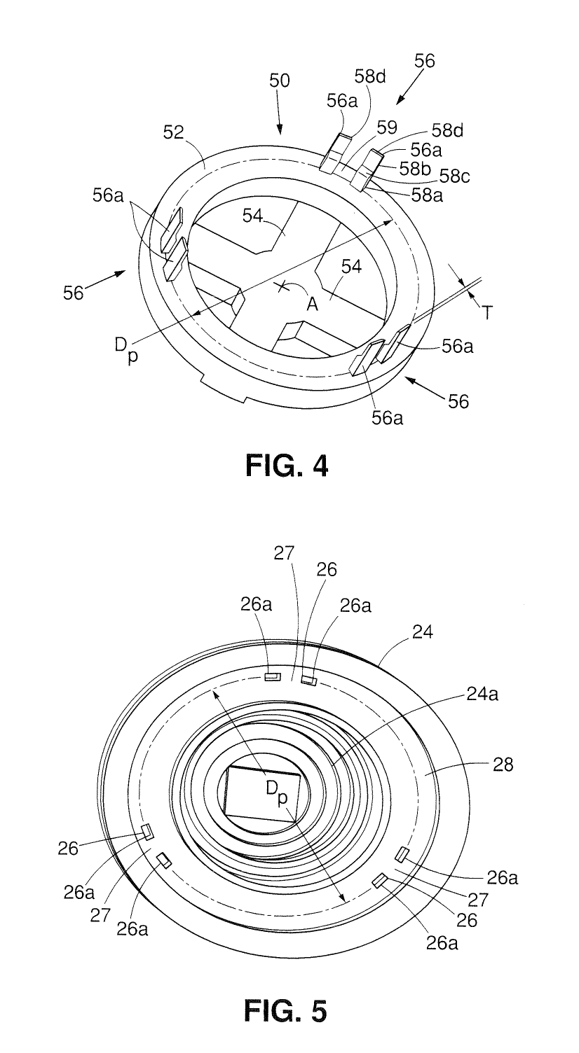

Each removal protrusion structure 56 can include a pair of adjacent wedge or spreading insertable removal protrusions, members or tabs 56a which are spaced apart from each other by a gap 59. The removal protrusions 56a can be positioned side by side along a straight line, or along an arc of pitch circle diameter Dₚ. In the embodiment depicted in FIG. 4, for use with a display assembly 10 having three locking tabs 34 and locking recesses 40, removable tool 50 can have three pairs of removal protrusion structures 56 spaced equidistantly or 120° apart along pitch circle diameter Dₚ, resulting in a total of six removal protrusions 56a. The number and spacing of the removable protrusion structures 56 and protrusions 56a can vary, and can depend upon the number and spacing of locking tabs 34. Each removal protrusion 56a can extend axially or longitudinally, generally parallel to central axis A and can have a generally flattened rectangular cross section with a stem 58a and a narrow insertion tip 58b extending from the stem 58a. The generally flattened surfaces of the stem 58a and insertion tip 58b of the removal protrusion 56a can face radially inwardly relative to axis A and can have an angled portion 58c connecting the insertion tip 58b to the stem 58a on the side facing radially inwardly. In some embodiments, the insertion tip 58b can extend from the body 52. The end 58d of the insertion tip 58b can be angled or rounded for aiding insertion and spreading.

The lens assembly housing 24 can include a series of axially or longitudinally facing tool protrusion access or insertion regions 26 positioned within shoulder or face 28 which correspond to the locking tabs 34 and the locking recesses 40 of the base housing 18. The insertion regions 26 can allow axial or longitudinal insertion of the removal protrusion structures 56 of the removable tool 50. The insertion regions 26 can be spaced in a generally circular pattern equidistantly from each other about axis A, and can include three insertion regions 26 spaced about 120° apart from each other for a lens assembly housing 24 having three locking tabs 34. The insertion regions 26 can be positioned along a circle that can be close to or along the pitch circle diameter Dₚ. Each insertion region 26 can include a pair of adjacent insertion holes or openings 26a spaced apart from each other by a gap, space, region or distance 27, and shaped to allow the insertion of removal protrusions 56a. Each opening 26a can be generally rectangular in shape and can be positioned on opposite sides of a locking tab 34. The openings 26a can be spaced apart by a distance 27 and in an orientation that corresponds to the spacing of the removal protrusions 56a and distance 27 can be about the same as the width of locking tab 34.

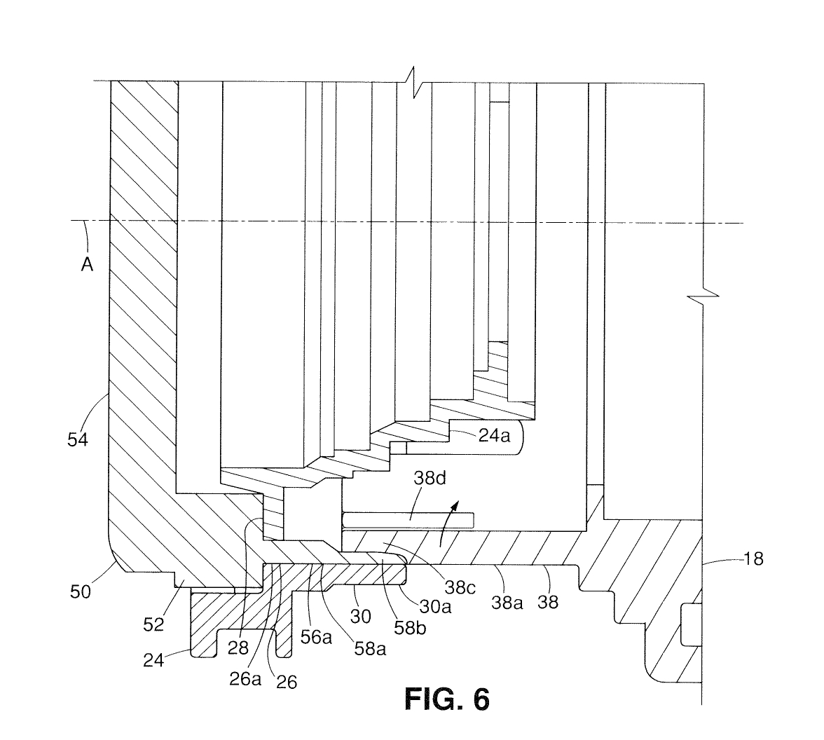

In use, the removable tool 50 can be axially or longitudinally aligned with the display assembly 10 along axis A and the removal protrusions 56a of the removal protrusion structures 56 can be simultaneously axially positioned and inserted axially or longitudinally through the openings 26a of the insertion regions 26 in the face 28 of the lens assembly housing 24 of the lens assembly 20. The openings 26a and the removal protrusions 56a can be positioned or arranged close to or generally on the pitch circle diameter Dₚ relative to axis A, to allow insertion of the removal protrusions 56a into the lens assembly housing 24 between the flange 30 of the lens assembly housing 24 and the deflectable flange members 38a of the flange 38 of the base housing 18. Referring to FIG. 6, the openings 26a and removal protrusions 56a can be radially positioned for insertion of the removal protrusions 56a through face 28 and then to slide axially or longitudinally along or against the inner diameter or surface of flange 30, and/or the outer diameter or surface of the deflectable flange members 38a. Each pair of removal protrusions 56a can be simultaneously axially inserted between the inner diameter of flange 30 and the outer diameter of flange 38 on opposite lateral sides of a locking tab 34. As the removal protrusions 56a simultaneously slide between flange 30 and flange 38, the thickness T of the removal protrusions 56a can act as a wedge to spread the flanges 30 and 38 apart from each other. The flange 30 can provide support on the outside of the removal protrusions 56a to prevent any significant deflection of the removal protrusions 56a radially outwardly by the deflectable flange members 38a. In one embodiment, the wedging or spreading can be provided by the insertion tip 58b of the removal protrusions 56a. In other embodiments, wedging or spreading can be also provided by the angled portion 58c and/or the stem 58a.

The deflectable flange members 38a of the flange 38 can simultaneously deflect and be forced radially inwardly towards axis A and away from the locking tabs 34, flange 30 and pitch circle diameter Dₚ. As the deflectable flange members 38a are forced away from the locking tabs 34, the locking recesses 40 and the locking tabs 34 can simultaneously radially disengage from each other. The removal protrusions 56a can have a thickness T that is at least slightly greater than the height of shoulder 36 of locking tab 34 to provide sufficient wedging or spreading for disengagement of the shoulder 36 of the locking tab 34 from the distal side 40a of the locking recess 40. Having a pair of removal protrusions 56a in each removal protrusion structure 56 enables two removal protrusions 56a to provide wedging or spreading close to and on opposite sides of each locking tab 34. This can ensure that both sides of the locking tabs 34 can be disengaged from the locking recesses 40 by evenly deflecting the deflectable flange members 38a on opposite sides of the locking tabs 34 and the locking recesses 40 with the pair of removal protrusions 561. Centrally positioning the locking recesses 40 on the deflectable flange members 38a can allow the deflectable flange members 38a to deflect evenly since the wedging or spreading by the removal protrusions 56a is on opposite sides of the locking recesses 40. The simultaneous circular disengagement of the multiple locking tabs 34 and locking recesses 40 from each other along or about the pitch circle diameter Dₚ can allow the lens assembly housing 24 and lens assembly 20 to be separated and removed from the base housing 18 without damage to the housings 24 and 18.

Referring to FIG. 7, in another embodiment, the flange 30 of the lens assembly housing 24 can have nine radial locking tabs 34 which can be arranged in three spaced apart groups 60, each having three radial locking tabs 34, for engaging nine locking recesses 40, arranged in three corresponding spaced apart groups 62 on the flange 38 of the base housing 18, each having three locking recesses 40. Each group 60 and 62 can be associated with a deflectable flange member 38a. The removable tool 50 corresponding to this locking arrangement can include three removal protrusion structures 56, each having two pairs of removal protrusions 56a (four) for insertion adjacent to and between the three radial locking tabs 34 of a group 60. This can result in a removable tool 50 having a total of twelve removal protrusions 56a. In other embodiments, the groups 60 and 62 can each have two, or more than three, radial locking tabs 34 and locking recesses 40, and the number of the removal protrusions 56a in each removal protrusion structure 56 can vary.

In other embodiments, the number of the removal protrusions 56a, locking tabs 34, deflectable flange members 38a and locking recesses 40 can vary. The removal protrusions 56a, openings 26a, locking tabs 34 and recesses 40 can have other suitable shapes. For example, the removal protrusions 56a can have a curved, round, triangular or polygonal cross section. The removal protrusions 56a can taper or curve or be pointed to provide the desired thickness T for providing disengagement. In addition, the locking tabs 34 can be curved or round. Also, the locking recesses 40 can be blind holes or can be a circumferential groove. In some embodiments, the deflectable flange members 38a of the base housing 18 can include locking protrusions 34 for engaging locking recesses 40 in the flange 30 of the lens assembly housing. Also the flange 30 can be configured for deflecting outwardly for disengagement. The locking tabs 34 and recesses 40 can in some situations be unevenly spaced apart from each other. Each removal protrusion structure 56 of the removable tool 50 can have one removal protrusion 56a for insertion adjacent to a locking tab 34 instead of pairs. The housings 24 and 18 can be made of suitable plastics or metals. Furthermore, although the flange 30 lens been shown in the figures to fit over or outside flange 38, in other embodiments, flange 30 can fit within or inside flange 38. Although flanges 30 and 38 have been described to be generally cylindrical or curved, other embodiments, flanges 30 and 38 can be polygonal or have flat or planar surfaces or members. The display assembly 10 and components therein, and the removable tool 50 have been described relative to one central or longitudinal axis A for simplicity of description, and it is understood that each component when disassembled from each other, can have its own separate central or longitudinal axis.

While this invention has been particularly shown and described with references to example embodiments thereof, it will be understood by those skilled in the art that various changes in form and details may be made therein without departing from the scope of the invention encompassed by the appended claims.

For example, display assembly 10 can be an eyepiece viewing device, or can be other viewing devices. In addition, the locking and removal features described can be or used in other devices having a lens assembly which may or may not include a display aligned with the lens assembly, for example, a camera, binoculars, telescope, projector, etc.

What is claimed is:

1. A removable tool for a display assembly, the display assembly including a base housing, a lens assembly mounted to the base housing by a plurality of radial locking tabs extending from one of the lens assembly and the base housing, and a display unit having a matrix display contained within a display housing mounted in optical alignment with the lens assembly, the removable tool comprising:
a body having a series of removal protrusions corresponding to the radial locking tabs of the one of the lens assembly and the base housing which are simultaneously axially positionable and insertable inline with openings in the lens assembly to simultaneously disengage the radial locking tabs upon insertion of the removal protrusions into the openings in the lens assembly, thereby disassembling the lens assembly from the base housing.

2. The removable tool of claim 1 in which the series of removal protrusions extend from the body in a generally circular pattern relative to a central axis.

3. The removable tool of claim 2 in which the series of removal protrusions include pairs of removal protrusions adjacent to each other, each pair being spaced equidistantly from each other.

4. The removable tool of claim 3 in which each removal protrusion has a generally flattened rectangular cross section.

5. The removable tool of claim 4 in which each removal protrusion has a stem extending from the body with a narrow insertion tip extending from the stem.

6. The removable tool of claim 5 in which each removal protrusion has an angled portion connecting the insertion tip to the stem on a side facing radially inwardly relative to the central axis.

7. The removable tool of claim 2 in which the removal protrusions extend perpendicularly from a planar face of the body and parallel relative to the central axis.

8. A removable tool and display assembly combination, comprising:
a base housing;
a lens assembly mounted to the base housing by a plurality of radial locking tabs extending from one of the lens assembly and the base housing;
a display unit having a matrix display contained within a display housing mounted in optical alignment with the lens assembly; and
a removable tool having a series of removal protrusions corresponding to the radial locking tabs of the one of the lens assembly and the base housing which are simultaneously axially positionable and insertable inline with openings in the lens assembly to simultaneously disengage the radial locking tabs upon insertion of the removal protrusions into the openings in the lens assembly, thereby disassembling the lens assembly from the base housing.

9. The combination of claim 8 in which the series of removal protrusions extend from a body in a generally circular pattern relative to a central axis.

10. The combination of claim 9 in which the series of removal protrusions include pairs of removal protrusions adjacent to each other, each pair being spaced equidistantly from each other.

11. The combination of claim 10 in which each removal protrusion has a generally flattened rectangular cross section.

12. The combination of claim 11 in which each removal protrusion has a stem extending from the body with a narrow insertion tip extending from the stem.

13. The combination of claim 12 in which each removal protrusion has an angled portion connecting the insertion tip to the stem on a side facing radially inwardly relative to the central axis.

14. The combination of claim 9 in which the removal protrusions extend perpendicularly from a planar face of the body and parallel relative to the central axis.

15. The combination of claim 8 in which the radial locking tabs extend radially inwardly from the lens assembly for engaging a mating locking structure in the base housing.

16. The combination of claim 15 in which the base housing includes three deflectable flange members, each having a locking recess for engaging a corresponding radial locking tab, the deflectable flange members capable of being deflected radially inwardly by the removal protrusions for disengaging the radial locking tabs from the locking recesses in the deflectable flange members.

17. The combination of claim 16 in which the deflectable flange members are segments of a cylindrical member separated from each other by slots to allow deflection radially inwardly.

18. A display assembly comprising:
a base housing having a series of deflectable flange members comprising segments of a cylindrical member separated from each other by slots to allow deflection radially inwardly;
a lens assembly mounted to the base housing by a plurality of radial locking tabs extending from one of the lens assembly and the deflectable flange members of the base housing, the lens assembly including openings for allowing simultaneous axial insertion of a series of removal protrusions from a removable tool corresponding to the radial locking tabs to simultaneously disengage the radial locking tabs by deflecting the deflectable flange members radially inwardly upon insertion of the removal protrusions into the openings in the lens assembly, thereby disassembling the lens assembly from the base housing when desired; and
a display unit having a matrix display contained within a display housing mounted in optical alignment with the lens assembly.

19. The display assembly of claim 18 in which three radial locking tabs extend radially inwardly from the lens assembly for engaging a mating locking structure in the base housing.

20. The display assembly of claim 19 in which the base housing includes three deflectable flange members, each having a locking recess for engaging a corresponding locking tab.

21. A method of removing a lens assembly from a display assembly, the display assembly including a base housing, with the lens assembly mounted to the base housing by a plurality of radial locking tabs extending from one of the lens assembly and the base housing, and a display unit comprising a matrix display contained within a display housing mounted in optical alignment with the lens assembly, the method comprising simultaneously axially inserting removal protrusions of a removable tool corresponding to the radial locking tabs inline with openings in the lens assembly to simultaneously disengage the radial locking tabs, thereby disassembling the lens assembly from the base housing.

22. The method of claim 21 further comprising extending the removal protrusions from a body and positioned in a generally circular pattern relative to a central axis.

23. The method of claim 22 further comprising inserting pairs of removal protrusions that are adjacent to each other, each pair being spaced equidistantly from each other.

24. The method of claim 23 further comprising inserting removal protrusions that have generally flattened rectangular cross sections.

25. The method of claim 24 further comprising inserting removal protrusions, each having a stem with a narrow insertion tip.

26. The method of claim 25 further comprising inserting removal protrusions, each having an angled portion connecting the insertion tip to the stem on a side facing radially inwardly relative to the central axis.

27. The method of claim 22 further comprising inserting removal protrusions that extend perpendicularly from a planar face of the body and parallel relative to the central axis.

28. The method of claim 21 further comprising disengaging three radial locking tabs that extend radially inwardly from the lens assembly from a mating locking structure in the base housing.

29. The method of claim 28 further comprising deflecting radially inwardly three deflectable flange members of the base housing, each having a locking recess engaging a corresponding radial locking tab, deflection of the deflectable flange members disengaging the radial locking tabs from the locking recesses.

30. The method of claim 29 further comprising deflecting deflectable flange members which are segments of a cylindrical member separated from each other by slots to allow deflection radially inwardly.

31. A method of forming a display assembly comprising:
providing a base housing having a series of deflectable flange members comprising segments of a cylindrical member separated from each other by slots to allow deflection radially inwardly;
mounting a lens assembly to the base housing with a plurality of radial locking tabs extending from one of the lens assembly and the deflectable flange members of the base housing, the lens assembly including openings for allowing simultaneous axial insertion of a series of removal protrusions of a removable tool corresponding to the radial locking tabs to simultaneously disengage the radial locking tabs by deflecting the deflectable flange members radially inwardly, thereby disassembling the lens assembly from the base housing when desired; and
mounting a display unit having a matrix display contained within a display housing in optical alignment with the lens assembly.

32. The method of claim 31 further comprising extending three radial locking tabs radially inwardly from the lens assembly for engaging a mating locking structure in the base housing.

33. The method of claim 32 further comprising providing the base housing with three deflectable flange members, each having a locking recess for engaging a corresponding locking tab.
